(19) United States
(12) Patent Application Publication
(10) Pub. No.: US 2023/0358069 A1
(43) Pub. Date: Nov. 9, 2023

(54) Tilt Tower and Method of Assembly.

(71) Applicant: Wilbur L. Anderson, Inc., San Angelo, TX (US)

(72) Inventor: Charles A. Anderson, San Angelo, TX (US)

(73) Assignee: Wilbur L. Anderson, Inc., San Angelo, TX (US)

(21) Appl. No.: 18/142,835

(22) Filed: May 3, 2023

Related U.S. Application Data
(60) Provisional application No. 63/338,854, filed on May 5, 2022.

(51) Int. Cl. E04H 12/34; F16C 3/02

(52) U.S. Cl. CPC E04H 12/345; F16C 3/02

(57) ABSTRACT

A tilt tower (10) is provided in which a tilt tube (14) rotates relative to a base tube (12) about an axle (16). The axle (16) is provided with a passageway therethrough, such that cables run between the base tube (12) and tilt tube (14) through the passageway.

### CROSS-REFERENCE TO RELATED APPLICATION AND PRIORITY INFORMATION

This application claims the benefit of, and priority from, co-pending, prior filed U.S. provisional application No. 63/338,854, entitled “Tilt Tower and Method of Assembly”, filed May 5, 2022.

### TECHNICAL FIELD OF THE INVENTION

This invention relates generally to tilt towers.

### BACKGROUND OF THE INVENTION

Tilt towers have various applications, including, without limitation, for use with antennae. Tilt towers generally include a base (or mast) tube and a tilt (or swing) tube connected by an axle. One end of the base tube (the near end) is usually engaged with a foundation or otherwise fixed, and the axle is coupled near its other end (the removed end). The axle is also coupled to a central portion of the tilt tube, allowing the tilt tube to rotate relative to the base tube.

During normal operation, the tilt tube is generally parallel to the base tube, with one end (the equipment end) of the tilt tube at its farthest distance from the near end of the base tube, and the other end secured to the base tube. This operating position is sometimes referred to as the erected position. For installation or maintenance of the antennae (or whatever may be attached to the tilt tube), the tilt tube is rotated relative to the base tube so that the antenna end is near the ground. This position is sometimes referred to as the tilted position. In this way, installation and maintenance personnel do not have to climb the tower, and climbing features are not needed on the tower.

In communications applications, one or more communications and/or power cables connect the antennae to communications equipment (often located in an electronics equipment enclosure near the ground level).

### SUMMARY OF THE INVENTION

In accordance with the teachings of the present invention, a tilt tower is provided which comprises a base tube, a tilt tube, and an axle coupled between the base tube and the tilt tube, the axle having a passageway allowing access between the base tube and the tilt tube, the axle configured to allow the tilt tube to rotate relative to the base tube. The axle may be hollow, and the passageway may be the hollow.

In a particular embodiment, the axle is fixedly coupled to the tilt tube and rotatably coupled to the base tube, and may rotate on an axle bearing surface. In another embodiment, the axle is fixedly coupled to the base tube, and the tilt tube is rotatably coupled to the axle.

In a particular embodiment, the axle comprises a flange, and further comprising members that form an annular space in which the flange rotates. In one embodiment, the members are coupled to the base tube. The members may comprise one or more plates. In another embodiment, the members are coupled to the tilt tube.

In another embodiment, the axle comprises a first threaded member coupled to the base tube and a second threaded member coupled to the tilt tube, the threaded members comprising complimentary threads that allow relative rotation of the threaded members so that the tilt tube is operable to rotate relative to the base tube.

In one embodiment, the tilt tower further comprises a communications cable, the communications cable running through the passageway and through at least a portion of the base tube and at least a portion of the tilt tube.

Also provided is a method of assembling a tilt tower comprising positioning a flange of an axle within an annular rotational space, the axle having a passageway therethrough; coupling the axle between a base tube and a tilt tube; and running a communications cable through the passageway and at least a portion of the base tube and at least a portion of the tilt tube. In one particular embodiment, coupling the axle comprises rotatably coupling the axle to the base tube. In another embodiment, coupling the axle comprises rotatably coupling the tilt tube to the axle. In one embodiment, coupling the axle comprises securing the flange. In a particular embodiment, coupling the axle comprises securing the flange between one or more plates.

Important technical advantages are provided by the present invention. In particular, and without limitation, cables may be run through the passageway of the axle, thereby allowing the tilt tube to be rotated from its operating position to a maintenance position without uncoupling or stressing the cables, without the need for additional connectors, and without undesirable exposure of the cables or conduits to the elements.

### BRIEF DESCRIPTION OF THE DRAWINGS

Reference is made in the description to the following briefly described drawings, which are not drawn to scale, and in which like reference numerals indicate like features:

FIG. 1 illustrates a tilt tower according to the teachings of the present invention;

FIG. 2 illustrates a perspective sectional view of an axle and portions of base and tilt tubes with cables according to the teachings of the present invention;

FIG. 3 illustrates perspective view of an axle and portions of base and tilt tubes with cables according to the teachings of the present invention;

FIG. 4 illustrates a sectional view of an axle and portions of base and tilt tubes with cables according to the teachings of the present invention;

FIG. 5 illustrates a perspective view of an axle and portions of base and tilt tubes in an erected position according to the teachings of the present invention;

FIG. 6 illustrates a perspective view of an axle and portions of base and tilt tubes in a rotated position according to the teachings of the present invention;

FIG. 7 illustrates a side view of a tilt tube and axle according to the teachings of the present invention;

FIG. 8 illustrates a sectional view (along lines A-A) of FIG. 7;

FIG. 9 illustrates a front view of an axle flange according to the teachings of the present invention;

FIG. 10 illustrates a side view of an axle shaft according to the teachings of the present invention;

FIG. 11 illustrates a partially exploded side view of flange receiving members according to the teachings of the present invention;

FIG. 12 illustrates a back plate according to the teachings of the present invention;

FIG. 13 illustrates a bottom spacer plate according to the teachings of the present invention;

FIG. 14 illustrates a top spacer plate according to the teachings of the present invention;

FIG. 15 illustrates a bottom front plate according to the teachings of the present invention;

FIG. 16 illustrates a top front plate according to the teachings of the present invention;

FIG. 17 illustrates a partially exploded perspective view of an axle and portions of base and tilt tubes according to the teachings of the present invention; and

FIG. 18 illustrates another embodiment of an axle and portions of base and tilt tubes according to the teachings of the present invention.

### DETAILED DESCRIPTION OF THE INVENTION

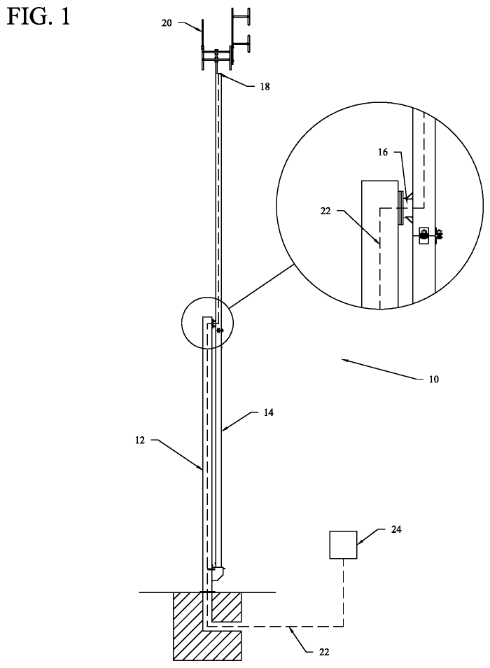

FIG. 1 illustrates a tilt tower 10 having a base tube 12, a tilt tube 14, and an axle 16. Tilt tube 14 includes an equipment end 18 to which equipment 20, such as antennae, are coupled. Although antennae are often used with tilt towers, any suitable equipment or device could be coupled to the equipment end 18. Equipment may be coupled to equipment end 18 in any suitable way, for example, and without limitation, such as is disclosed in U.S. Pat. No. 8,800,219 B2, which is incorporated herein, in its entirety, by reference. Tilt tube 14 may be made of one or more sections; the particular tilt tube shown has two sections, joined in any suitable way (for example, and without limitation, by a slip joint).

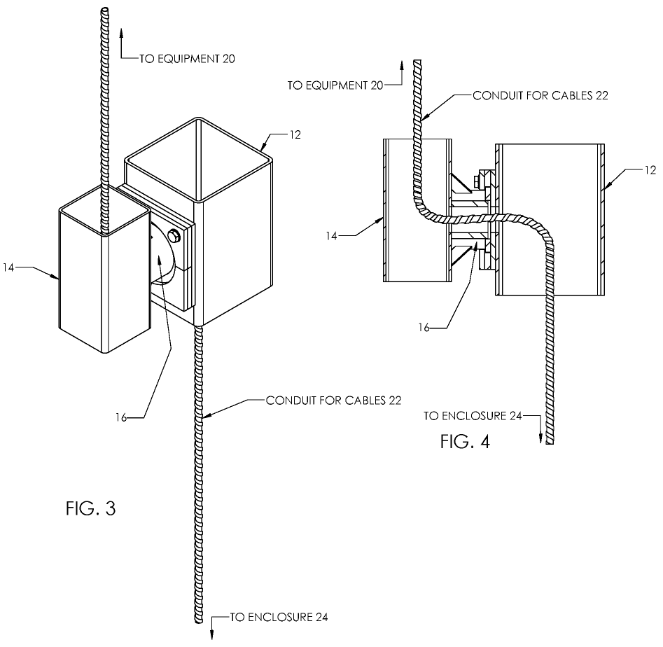

One or more electrical cables 22 run between equipment 20 and an electronics equipment enclosure 24. As shown in FIGS. 1, 2, 3, and 4, axle 16 is hollow (or otherwise includes a passageway), which allows electrical cables 22 to run through axle 16. As shown, cables 22 should run through a conduit, such as flexible metal cable conduit, although any suitable conduit may be used. However, no conduit is necessary. The cables may comprise any suitable cable or cables or mixtures of cables. For example, and without limitation, the cables may include one or more coaxial cables, one or more CAT 6 cables, one or more backup cables, one or more power cables, and any combination of cables.

As shown in FIGS. 1, 2, 3, and 4, cables 22 run between equipment 20 and enclosure 24 through tilt tube 14, axle 16, and base tube 12. At the near end of base tube 12, the cables emerge from base tube 12 to run to the enclosure 24. The cables 22 may run from the base tube 12 to the enclosure 24 in any suitable way, for example through intermediate channels, conduits, or connectors. Similarly, at the equipment end 18 of tilt tube 14, the cables emerge from tilt tube 14 for connection to the equipment 20 in any suitable way.

Axle 16 of the present invention provides significant advantages. In particular, and without limitation, with cables 22 running through the passageway of axle 16, tilt tube 14 can be rotated from its operating position to a maintenance position without uncoupling or stressing the cables. In some prior systems, cables run through tilt tube 14, from its equipment end 18 to its other end, where they emerge for connection to other equipment. In such prior systems, the cables must be disconnected at this other end before rotating the tilt tube for maintenance, and then reconnected after rotating the tilt tube back to its operating position. Such disconnection and reconnection result in more maintenance (and installation) time, extra steps, and opportunities for errors. Furthermore, disconnection and reconnection require the use of connectors, which may result in signal attenuation and the introduction of noise. In many communications applications, signal strength is important, and the attenuation and/or noise introduced by extra connectors may be unacceptable, or result in other costs to boost or filter the signal to overcome the connector issues. In some other prior systems, cables run through the base tube, from its near end toward the axle, and then emerge from the base tube near the axle to divert around the axle for entry into the tilt tube, and then complete their run to the equipment through the tilt tube. In such diverted cable runs, extra connectors may be avoided, but the diverted section around the axle is unsightly. Furthermore, the diverted section is exposed to the weather, and is subject to flex forces when the tilt tube is rotated, thus creating opportunities for failure that are not easy to address, since they occur at the removed end of the base tube, relatively high off the ground.

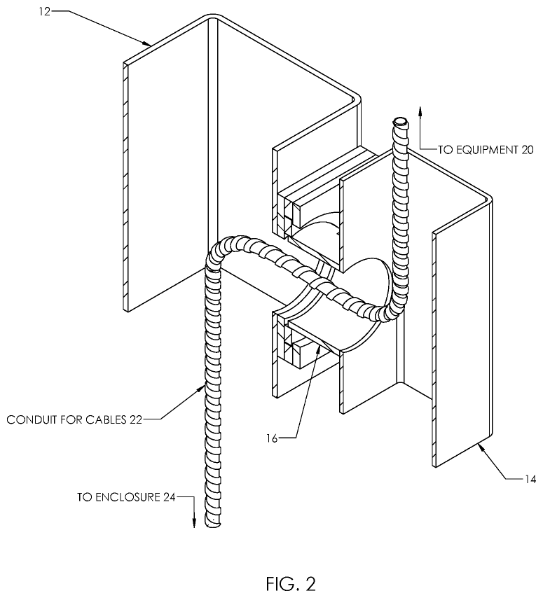

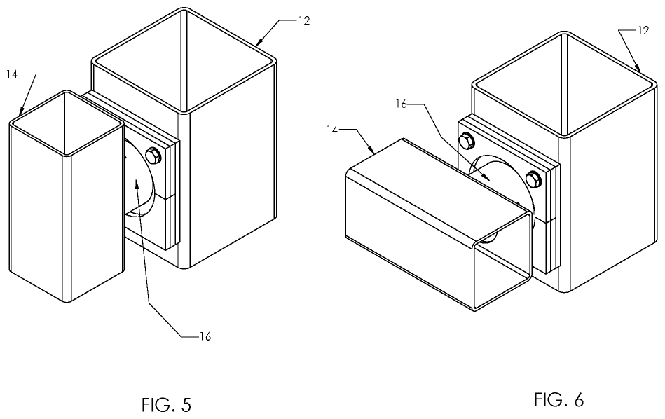

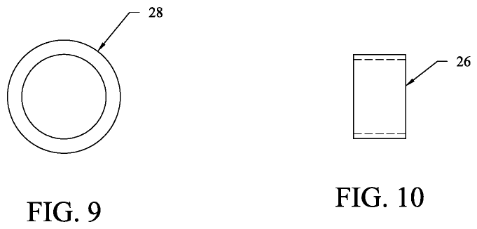

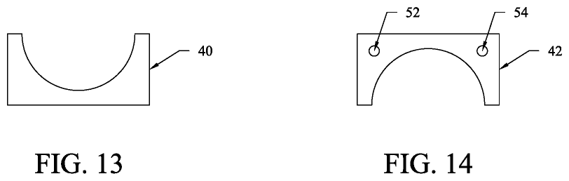

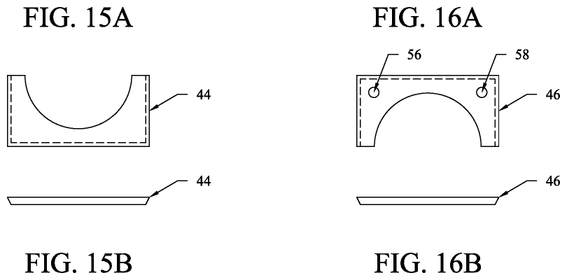

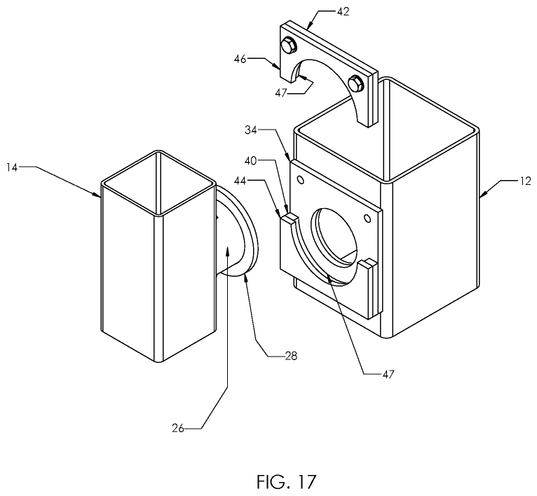

FIGS. 2-17 illustrate one particular embodiment of the present invention. FIGS. 5 and 6 illustrate rotation of the tilt tube 14 by showing portions of the base tube 12 and tilt tube 14 near the axle 16. In FIG. 5, the tilt tube 14 is in the erected, or operation, position, substantially parallel to the base tube 12. In FIG. 6, the tilt tube 14 is rotated into a tilted position.

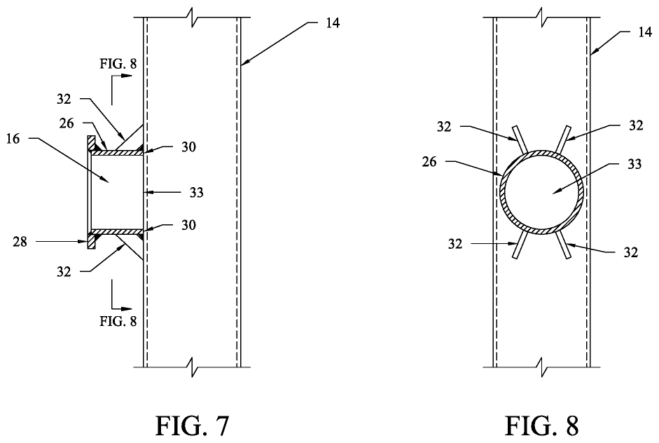

FIGS. 7-17 illustrate details of the axle 16 and associated components of this embodiment. In particular, as shown in FIGS. 7, 8, 9, and 10, in this embodiment, axle 16 comprises a hollow shaft 26 and a flange 28. Flange 28 may be formed integrally with shaft 26, or attached to shaft 26 in any suitable way, for example by welding. End 30 of shaft 26, which is opposite the flange 28, is fixedly attached to tilt tube 14 in any suitable way, for example by welding. Gussets 32 may be used to buttress the connection of shaft 26 to tilt tube 14, and may be attached in any suitable way, for example by welding. Tilt tube 14 includes an opening 33 between the inside of the tilt tube 14 and the axle 16, to allow passage of cables.

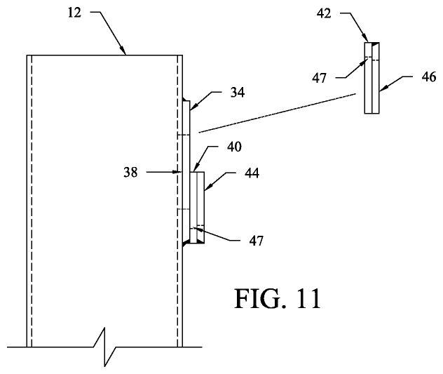

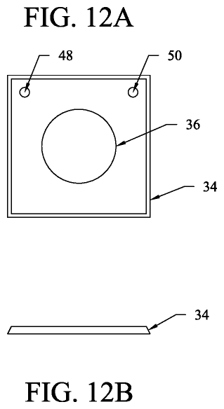

FIGS. 11-16 show, for this embodiment, components for receiving the axle 16 to facilitate rotation of the tilt tube 14. A back plate 34 is connected to base tube 12 in any suitable way, for example by welding. As shown in FIG. 12, back plate 34 includes an opening 36 therethrough, through which cables 22 run. Base tube 12 also includes an opening 38 that is at least partially aligned with opening 36 to create a passageway for the cables 22 to run through base tube 12 and axle 16.

Also provided is a bottom spacer plate 40, a top spacer plate 42, a bottom front plate 44, and a top front plate 46. In this particular embodiment, each of the plates 40-46 is generally rectangular in shape, each with a semicircular void to receive the axle 16. As shown, the location of the center of each semicircular void is located at the center of one of the long edges of the rectangle. The radius of the semicircular void on spacer plates 40 and 42 is approximately the same as, but slightly greater than, the radius of the outside diameter of flange 28, to allow the flange 28 (and therefore axle 16 and tilt tube 14) to rotate. The radius of the semicircular void on front plates 44 and 46 is less than the radius of the outside diameter of the flange 28, but greater than the radius of the outside diameter of shaft 26. The front plates 44 and 46 thereby retain the flange 28 and allow rotation of the axle 16 and tilt tube 14. An annular space 47 (see e.g., FIGS. 11 and 17) is created between back plate 34 front plates 44 and 46 because of the difference in the radius of the semicircular voids of front plates 44 and 46 and the radius of the semicircular voids of spacer plates 40 and 42.

In its assembled state (see, e.g., cross sectional FIG. 4), flange 28 bears on bottom spacer plate 40 (in particular on the edge of the plate defined by the semicircular void), and is able to rotate within the semicircular voids of spacer plates 40 and 42, between back plate 34 and front plates 44 and 46. Grease or any suitable lubricant may be applied to the surfaces of this rotational space, and in particular to spacer plate 40 along the perimeter of its semicircular void, to facilitate smooth rotation.

As shown in FIGS. 12, 14, and 16, bolt holes 48 and 50 (in base plate 34), 52 and 54 (in top spacer plate 42), and 56 and 58 (in top front plate 46) are provided to receive bolts for securing the plates 42 and 46. In particular, one bolt engages holes 48, 52, and 56, and one bolt engages holes 50, 54, and 58. The holes may be threaded, and base tube 12 may also include holes to receive the bolts. Although bolts are shown, any suitable approach may be used to secure plates 42 and 46.

FIG. 17 shows a partially exploded view of the axle 16 and associated components of this embodiment.

With this embodiment, a tilt tower may be easily assembled, whether in the field or before shipping. In a particular method, the base plate 34 and bottom plates 40 and 44 are secured to the base tube 12. The flange 28 of axle 16 is then positioned against base plate 34, with part of flange 28 positioned within the annular space 47 between back plate 34 and bottom front plate 44. Next, top spacer plate 42 is put in place, with its semicircular void surrounding flange 28. Top front plate 46 is then positioned against top spacer plate 42, in position to retain flange 28. The top plates 42 and 46 are then secured, for example by bolts engaged with holes 48-58.

In one embodiment of the present invention, an axle with a flange is provided, and the flange is positioned within an annular rotational space, and then secured to allow rotation of a tilt tube relative to a base tube. One or more cables are run through a passageway in the axle, and through at least a portion of the base tube and at least a portion of the tilt tube.

The generally rectangular plates 40-46 are provided to facilitate assembly of the tilt tower, whether in the field or before shipping to the installation site. However, plates 40 and 42 may be joined or combined in a single generally square plate, as may be plates 44 and 46. Such generally square plates would be assembled around the flange 28, and secured in any suitable way, for example by welding or with bolts. Also, plates 40 and 44 may be joined or combined in a single piece, as may plates 42 and 46. Furthermore, base plate 34 may be omitted, with plates 40 and 42 coupled directly to the base tube 12, and positioned about the opening 38 to allow cables to pass through.

The embodiment described in connection with FIGS. 2-17 shows the axle shaft 26 fixedly coupled to the tilt tube 14, and the axle-receiving components (e.g., plates 34, 40, 42, 44, and 46) coupled to the base tube 12. However, this may be reversed (and associated methods adjusted accordingly), with the axle shaft fixedly coupled to the base tube 12, and axle-receiving components coupled to the tilt tube 14, such that the tilt tube 14 rotates around the axle 16.

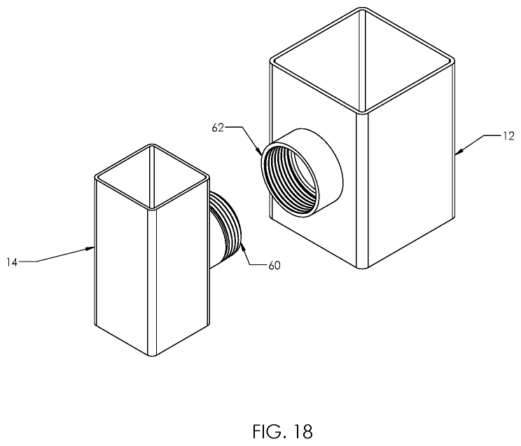

FIG. 18 illustrates another embodiment of the present invention, in which a hollow axle is formed with threaded members 60 and 62. In the illustrated example, member 60 is male and is coupled to or otherwise formed on tilt tube 14, and member 62 is female and is coupled to or otherwise formed on base tube 12; however, this can be reversed (the tilt tube member would be female, and the base tube member male). In operation, tilt tube 14 is rotated by the threaded rotation of member 60 with respect to member 62. As seen in FIG. 18, members 60 and 62 are hollow (or otherwise formed to have a passageway), and thus allow cables to pass through the axle.

As examples, the base tube, tilt tube, and axle parts in any of the embodiments may be made of steel, although any suitable material may be used.

In any of the methods of the present invention, if a tilt tube with two or more sections is used, sections of the tilt tube may be coupled together before or after coupling the axle between the tilt tube and the base tube (such as, without limitation, by coupling tilt tube sections at a slip joint).

Within this description, coupling includes direct connection and connection through one or more intermediate elements.

Within this description, tube refers to a member that has a passageway within all or any portion of it, for example, and without limitation, a hollow member, and is not limited to any particular shape. For example, the cross section of a tube herein may be any shape, including, without limitation, square, rectangular, any polygonal shape, round, oval, or any eccentric shape, and may change in cross section along its length.

Particular features of each embodiment may be used with, added to, or substituted in the other example embodiments. Furthermore, although the present invention has been described in detail, it should be understood that various changes, alterations, substitutions, additions, and modifications could be made without departing from the intended scope of the invention, as defined in the following claims.

What is claimed is:

1. A tilt tower, comprising:
a base tube;
a tilt tube; and
an axle coupled between the base tube and the tilt tube, the axle having a passageway allowing access between the base tube and the tilt tube, the axle configured to allow the tilt tube to rotate relative to the base tube.

2. The tilt tower of claim 1, wherein the axle is fixedly coupled to the tilt tube and rotatably coupled to the base tube.

3. The tilt tower of claim 2, and further comprising an axle bearing surface on which the axle rotates.

4. The tilt tower of claim 1, wherein the axle is fixedly coupled to the base tube, and wherein the tilt tube is rotatably coupled to the axle.

5. The tilt tower of claim 1, wherein the axle is hollow and the passageway is the hollow.

6. The tilt tower of claim 1, wherein the axle comprises a flange, and further comprising members that form an annular space in which the flange rotates.

7. The tilt tower of claim 6, wherein the members are coupled to the base tube.

8. The tilt tower of claim 6, wherein the members comprise one or more plates.

9. The tilt tower of claim 6, wherein the members are coupled to the tilt tube.

10. The tilt tower of claim 1, wherein the axle comprises a first threaded member coupled to the base tube and a second threaded member coupled to the tilt tube, the threaded members comprising complimentary threads that allow relative rotation of the threaded members so that the tilt tube is operable to rotate relative to the base tube.

11. The tilt tower of claim 1, and further comprising a communications cable, the communications cable running through the passageway and through at least a portion of the base tube and at least a portion of the tilt tube.

12. A tilt tower, comprising:
a base tube;
a tilt tube;
a communications cable, the communications cable running through at least a portion of the base tube and at least a portion of the tilt tube; and
an axle coupled between the base tube and the tilt tube, the axle having a passageway through which the communications cable runs, the axle configured to allow the tilt tube to rotate relative to the base tube.

13. A method of assembling a tilt tower, comprising:
positioning a flange of an axle within an annular rotational space, the axle having a passageway therethrough;
coupling the axle between a base tube and a tilt tube; and
running a communications cable through the passageway and at least a portion of the base tube and at least a portion of the tilt tube.

14. The method of claim 13, wherein coupling the axle comprises rotatably coupling the axle to the base tube.

15. The method of claim 13, wherein coupling the axle comprises rotatably coupling the tilt tube to the axle.

16. The method of claim 13, wherein coupling the axle comprises securing the flange.

17. The method of claim 13, wherein coupling the axle comprises securing the flange between one or more plates.
